(19) United States
(12) Patent Application Publication
(10) Pub. No.: US 2004/0194547 A1
(43) Pub. Date: Oct. 7, 2004

(54) Cavity and resonant ultrasonic spectroscopy apparatus using the same

(76) Inventors: Kenichi Tozaki, Chiba-shi (JP); Takuya Okazaki, Chiba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/610,571

(22) Filed: Jul. 2, 2003

(30) Foreign Application Priority Data
Jan. 27, 2003 (JP) 2003-017293

(51) Int. Cl. G01N 29/12

(52) U.S. Cl. 73/579; 73/668

(57) ABSTRACT

A cavity vibrates a sample and is combined with the sample to be equivalent to an LC circuit. An insulator electrically insulates the sample from the cavity. The insulator is placed between the sample and the cavity. A first output unit outputs, to the cavity, a first frequency signal including a frequency which causes the cavity combined with the sample to function as an equivalent circuit of an LC circuit. A second output unit outputs, to the sample and the cavity, a second frequency signal including a frequency which vibrates the sample. An amplitude detection unit detects, based on the second frequency signal, the amplitude of a reflected signal reflected from the cavity, the reflected signal being caused by the first frequency signal.

### CROSS-REFERENCE TO RELATED APPLICATIONS

This application is based upon and claims the benefit of priority from the prior Japanese Patent Application No. 2003-017293, filed Jan. 27, 2003, the entire contents of which are incorporated herein by reference.

### BACKGROUND OF THE INVENTION

1. Field of the Invention

The present invention relates to a cavity and a resonant ultrasonic spectroscopy apparatus using the cavity and, more particularly, to a cavity which is used to measure the displacement of a conductive surface, and a resonant ultrasonic spectroscopy apparatus using the cavity, which is used to measure the modulus of elasticity of a sample in developing and evaluating a new material.

2. Description of the Related Art

Conventional resonant ultrasonic spectroscopy apparatuses include a type in which a sample is sandwiched between two piezoelectric transducers (to be simply referred to as a P type hereinafter) (see, for example, Jpn. Pat. Appln. KOHYO 10-505408). Some conventional resonant ultrasonic spectroscopy apparatuses use an electromagnetic acoustic method (to be simply referred to as an EM type hereinafter) which uses a Lorenz force acting on an induced eddy current for excitation, and uses the induced electromotive force of the eddy current for detection of vibrations.

In order to measure the elastic constant of an object, it is indispensable to ensure high temperature stability for a sample to be measured. In a P type, however, since a sample is openly placed in a space, temperature control is difficult to perform. In an EM type, a sample is always heated by Joule heat generated by an eddy current, resulting in temperature unevenness.

It is therefore an object of the present invention to provide a cavity which allows high-precision measurement of a modulus of elasticity by keeping a sample temperature stable, and a resonant ultrasonic spectroscopy apparatus using the cavity.

### BRIEF SUMMARY OF THE INVENTION

According to an aspect of the present invention, there is provided a resonant ultrasonic spectroscopy apparatus which detects a property of a sample at least whose surface is a conductor, the apparatus comprising: a cavity which vibrates the sample and is combined with the sample to be equivalent to an LC circuit; an insulator which electrically insulates the sample from the cavity, the insulator being placed between the sample and the cavity; a first output unit configured to output, to the cavity, a first frequency signal including a frequency which causes the cavity combined with the sample to function as an equivalent circuit of an LC circuit; a second output unit configured to output, to the sample and the cavity, a second frequency signal including a frequency which vibrates the sample; and an amplitude detection unit configured to detect, based on the second frequency signal, an amplitude of a reflected signal reflected from the cavity, the reflected signal being caused by the first frequency signal.

In addition, according to another aspect of the present invention, there is provided a cavity which is placed, through an insulating material, in contact with a sample at least whose surface is a conductor and inputs a predetermined frequency signal, the cavity comprising a first projection part configured to be capacitively coupled to the sample; a second projection part configured to be capacitively coupled to the sample; and a connecting portion configured to connect the first projection part and the second projection part so as to form a hollow portion in the cavity, wherein one end of the first projection part and one end of the second projection part are electrically connected to each other, the other end of the first projection part and the other end of the second projection part are electrically insulated from each other, a coupling capacitance between the other end of the first projection part and the other end of the second projection part is smaller than each of a coupling capacitance between the sample and the first projection part and a coupling capacitance between the sample and the second projection part, and the connecting portion becomes a coil as an equivalent circuit upon reception of the frequency signal.

Furthermore, according to yet another aspect of the present invention, there is provided a cavity which is placed, through an insulating material, in contact with a sample at least whose surface is a conductor and to which a second frequency signal is input, comprising a first input part configured to input a first frequency signal; a second input part configured to input the second frequency signal; and a connecting portion part configured to be so formed as to form a hollow portion in the cavity, made of a conductor, and connected to the first input part and the second input part, wherein the cavity vibrates the sample based on the second frequency signal and is combined with the sample to function as an equivalent circuit of an LC circuit based on the first frequency signal.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the present invention and, together with the general description given above and the detailed description of the embodiments given below, serve to explain the embodiments of the present invention.

FIG. 1 is a block diagram of a resonant ultrasonic spectroscopy apparatus according to the first embodiment of the present invention;

FIG. 2A is a sectional view of a cavity and sample in FIG. 1;

FIG. 2B is a perspective view of the cavity in FIG. 1;

FIG. 2C is an enlarge view of the portion enclosed with a dotted line A in FIG. 2A;

FIG. 3A is a view showing a current flowing in the cavity in FIG. 1 and the direction of a magnetic field generated in the hollow portion of the cavity;

FIG. 3B is an equivalent circuit diagram of the cavity in FIG. 1 with a frequency signal of a frequency f₀ from an oscillator in FIG. 1;

FIG. 4 is a graph showing the amplitude of a reflected wave from the cavity in FIG. 1 as a function of the frequency of the frequency signal of the frequency f₀ from the oscillator in FIG. 1;

FIG. 5 is a graph showing the amplitude of an output signal from a detector in FIG. 1 as a function of time;

FIG. 6 is a graph showing the amplitude of an output signal from a lock-in amplifier in FIG. 1 as a function of frequency;

FIG. 7 is a block diagram of a resonant ultrasonic spectroscopy apparatus according to the second embodiment of the present invention; and

FIG. 8 is a diagram of a resonant ultrasonic spectroscopy apparatus according to the third embodiment of the present invention.

### DETAILED DESCRIPTION OF THE INVENTION

Embodiments of the present invention will be described with reference to the views of the accompanying drawings.

### FIRST EMBODIMENT

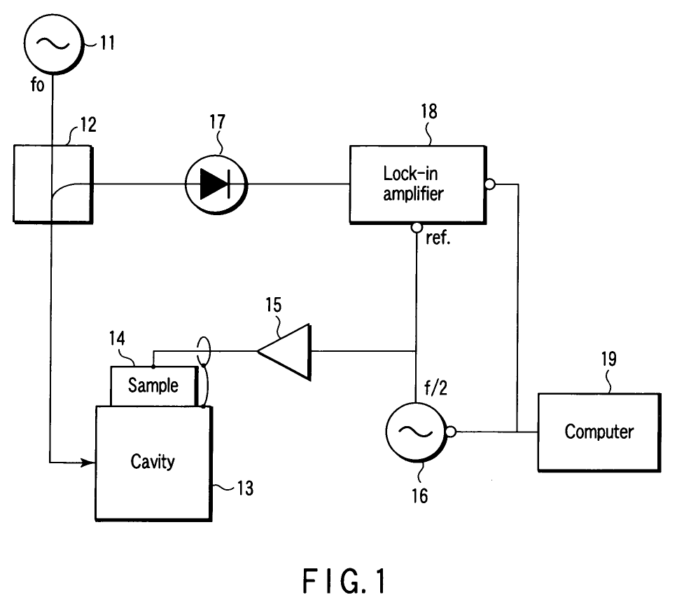

FIG. 1 is a block diagram showing a resonant ultrasonic spectroscopy apparatus according to the An oscillator 11 oscillates a frequency signal having a predetermined frequency f₀. The frequency f₀ is kept at a predetermined value while a sample 14 is measured. Before the sample 14 is measured, the frequency f₀ is set. The oscillator 11 outputs the oscillation frequency signal to a cavity 13 through a directional bridge 12.

The directional bridge 12 outputs a reflected signal from the cavity 13 to a detector 17 as well as outputting the frequency signal having the frequency f₀ to the cavity 13.

An oscillator 16 oscillates a frequency signal having a frequency f/2. This frequency f is determined by an instruction from a computer 19. In addition, the frequency f is swept over a predetermined frequency band in accordance with an instruction from the computer 19. The oscillator 16 outputs the oscillated frequency signal to a power amplifier 15 and lock-in amplifier 18. The lock-in amplifier 18 performs detection by referring to the frequency signal output from the oscillator 16.

The power amplifier 15 amplifies the power of the frequency signal output from the oscillator 16. The power amplifier 15 then outputs the amplified frequency signal to the sample 14 and cavity 13. The amplification factor of the power of a frequency signal is set so as not to cause a dielectric breakdown in a spacer 21. As the power of this frequency signal increases, the vibration amplitude of the sample 14 increases. This makes it easier for the lock-in amplifier 18 to detect an amplitude.

The cavity 13 is made of a metal and has a structure serving as an LC circuit, including the sample 14, in accordance with a frequency signal from the oscillator 11. In order to make the cavity 13 function as an LC circuit, the frequency of a signal output from the oscillator 11 must be adjusted in accordance with the size and the material of the cavity 13. The cavity 13 receives an amplified frequency signal from the power amplifier 15 and forms a capacitor as an equivalent circuit between itself and the sample 14 which has also received the amplified frequency signal. In the capacitor, when a voltage is applied between electrodes, an attractive force is generated between the electrodes. In this embodiment, since an AC voltage having the frequency f/2 is applied to the sample 14 and cavity 13, the sample 14 is vibrated by an electric force acting in a direction perpendicular to the surface of the counter electrode of the capacitor. In this embodiment, in the arrangement of the sample 14 and cavity 13 shown in FIG. 1, the sample 14 vibrates vertically. Therefore, the main resonant mode produced in the sample 14 is a longitudinal wave.

As is obvious from the above description as well, the sample 14 is so formed as to contain a metal. If a material to be measured is not a metal, a metal is attached to the surface of the sample 14. For example, a gold evaporated film is formed on the surface of the sample 14 before measurement. The sample 14 is generally a solid, but even a liquid or gas sample can be measured. If the sample 14 is a liquid or gas, the sample 14 is sealed in a vessel and placed on the cavity 13.

The detector 17 monitors a reflected signal output from the cavity 13. The lock-in amplifier 18 extracts a signal component having the frequency f from an output signal from the detector 17 with reference to a signal having the frequency f by referring to the frequency f/2 from the oscillator 16. That is, the lock-in amplifier 18 is synchronous with a reference clock from the oscillator 16. The lock-in amplifier 18 outputs the amplitude value of the extracted signal component to the computer 19. The lock-in amplifier 18 improves the S/N ratio of the received output signal from the detector 17.

The computer 19 designates a frequency that is swept over a given frequency band with respect to the oscillator 16, i.e., the frequency f, and outputs an instruction signal to the oscillator 16 to oscillate based on the frequency. The computer 19 receives and stores the amplitude value output from the lock-in amplifier 18. Output data from the lock-in amplifier 18 is a component having a frequency twice the frequency f/2 designated by the computer 19 with respect to the oscillator 16. The computer 19 controls the oscillator 16 and the lock-in amplifier 18 to perform automatic measurement based on frequency sweep operation.

A coaxial cable is used to connect the oscillator 11, directional bridge 12, cavity 13, sample 14, detector 17, lock-in amplifier 18, power amplifier 15, and oscillator 16. Note however that a general two-core cable may be used between the detector 17 and the lock-in amplifier 18, between the sample 14, the cavity 13, and the power amplifier 15, between the power amplifier 15 and the oscillator 16, and between the oscillator 16 and the lock-in amplifier 18.

The computer 19, oscillator 16, and lock-in amplifier 18 are connected through a GPIB (General Purpose Interface Bus). Obviously, they can be connected through a bus other than a GPIB as long as the computer 19 can control the oscillator 16 and lock-in amplifier 18. For example, they can be connected to each other through an RS-232C bus, USB (Universal Serial Bus), or the like.

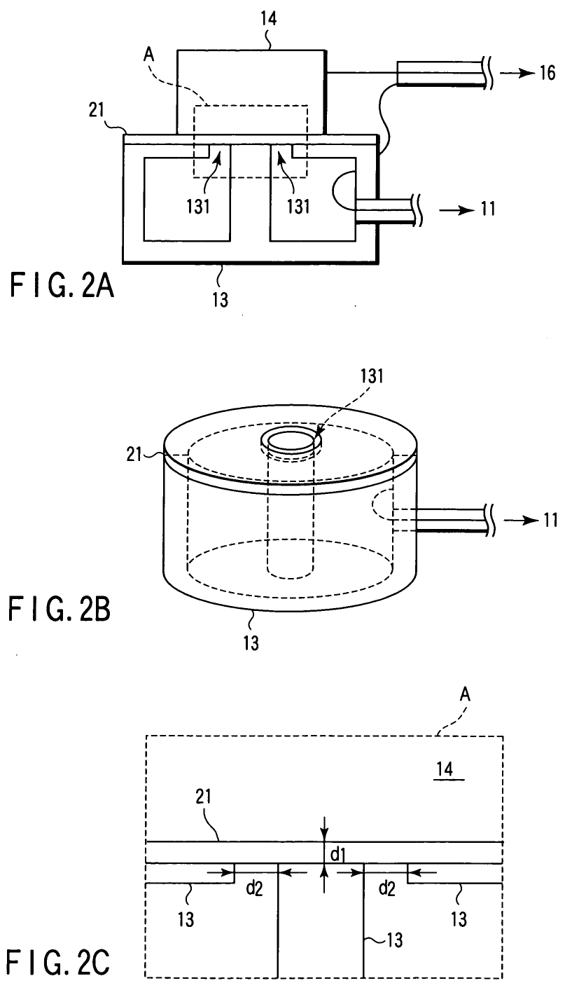

FIG. 2A is a sectional view of the cavity 13 and sample 14 in FIG. 1. FIG. 2B is a perspective view of the cavity 13 in FIG. 1. FIG. 2C is an enlarged view of the portion enclosed with the dotted line in FIG. 2A.

The spacer 21 is placed on the upper portion of the cavity 13. The spacer 21 is made of an insulator. As the spacer 21, any member can be used as long as it can provide electrical insulation. The sample 14 is stacked on the cavity 13 through the spacer 21.

As shown in FIGS. 2A and 2B, the cavity 13 has a cylindrical shape with a doughnut-shaped hollow portion formed inside. An annular hole is formed in only the upper portion of the cavity 13. This annular hole communicates with the doughnut-shaped hollow portion. The spacer 21 has an area large enough to allow the sample 14 to be stacked thereon while closing the annular hole, and is placed on the cavity 13. In this embodiment, the spacer 21 has a disk-like shape covering the upper portion of the cavity 13.

The central conducting wire or the conducting wire extending from the metal tube of the coaxial cable that connects the oscillator 16 and power amplifier 15 is connected to the sample 14, and the other conducting wire is connected to the cavity 13. Referring to FIGS. 2A and 2B, the central conducting wire is connected to the sample 14, and the conducting wire extending from the metal tube is connected to the cavity 13.

The coaxial cable that connects the oscillator 11 and directional bridge 12 is installed such that the central conducting wire or the conducting wire extending from the metal tube forms an area inside the hollow portion of the cavity 13. The other conducting wire is connected to the cavity 13. Referring to FIGS. 2A and 2B, the central conducting wire forms an area inside the hollow portion of the cavity 13, and the conducting wire extending from the metal tube is connected to the cavity 13. Referring to FIGS. 2A and 2B, the central conducting wire is placed in the form of a semicircle inside the hollow portion of the cavity 13.

The pair of the inside cavity portion of an annular hole 131 and the sample 14 and the pair of the outside cavity portion of the annular hole 131 and the sample 14 respectively form capacitors. The frequency signal output from the oscillator 16 is applied to the sample 14 and cavity 13 to activate these capacitors.

This capacitor structure is equivalent to that of a parallel-plate capacitor with the sample surface and the inside and outside cavity portions serving as electrodes. When a potential difference V is applied between the two electrodes of the parallel-plate capacitor with a dielectric constant ε of the inter-electrode material, an electrode area S, and an inter-electrode distance d, the electrodes attract each other with electric force F=εS(V/d)²/2. In this embodiment, since the oscillator 16 applies an AC voltage having the frequency f/2 as an application voltage between the two electrodes, an attractive force acts between the electrodes in accordance with the ratio of the frequency f. As a result, an electric force acting on the sample surface acts in a direction perpendicular to the surface of the counter electrode, and the sample 14 vibrates. If the sample 14 is a rectangular parallelepiped, the main resonant mode produced inside the sample is a longitudinal wave.

A capacitor can also be formed by the outside cavity portion and the inside cavity portion by capacitive coupling with the annular hole 131 being placed therebetween. As shown in FIG. 2C, however, a width d₂ of the annular hole formed in the upper portion of the cavity 13 is set to be large compared with a thickness d₁ of the spacer 21, and the facing area between a portion of the inside and an outside cavity portion of the annular hole 131 is also set to be small, which determines the electric capacitance of the capacitor. For this reason, the effect of the capacitor formed by the outside cavity portion and the inside cavity portion with the annular hole 131 being placed therebetween is negligibly smaller than that of the capacitor formed by the inside or outside cavity portion of the annular hole 131 and the sample 14.

Conversely, the thickness d₁ of the spacer 21, the width d₂ of the annular hole, and the area of a portion of the inside or outside cavity portion of the annular hole 131 which determines the electric capacitance of the capacitor are set such that the effect of the capacitor formed by the outside and the inside cavity portions with the annular hole 131 being placed therebetween becomes smaller than that of the capacitor formed by the inside or outside cavity portion of the annular hole 131 and the sample 14.

In other words, the shape of the cavity is set such that the coupling capacitance of the outside and inside cavity portions with the annular hole 131 being placed therebetween becomes negligibly smaller than that formed by the inside or outside cavity portion of the annular hole 131 and the sample 14.

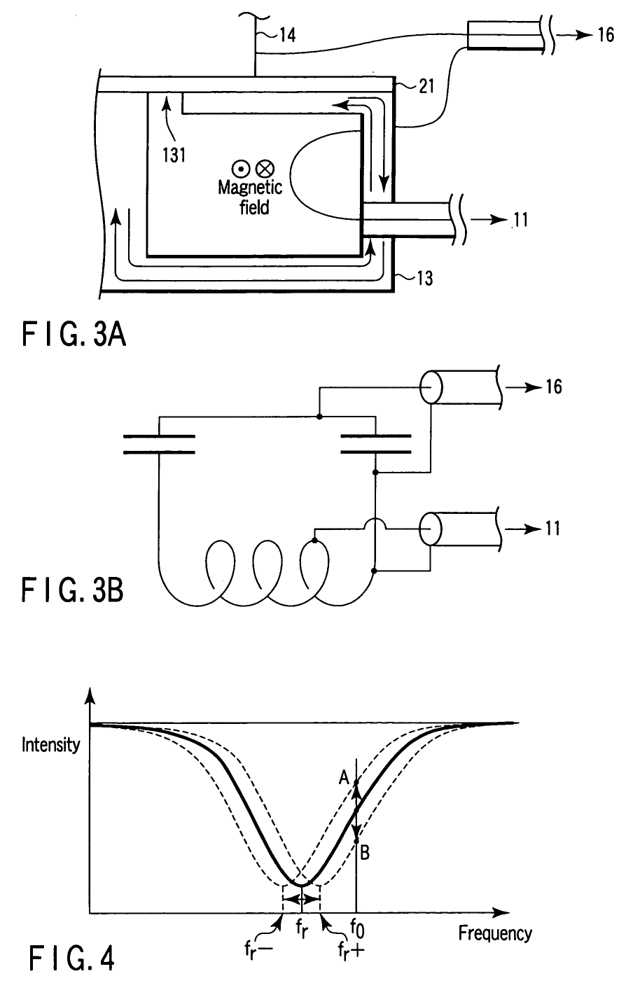

FIG. 3A is a view showing a current flowing in the cavity 13 and the direction of a magnetic field generated in the hollow portion of the cavity 13. FIG. 3B is an equivalent circuit diagram of the cavity in FIG. 1 based on a frequency signal from the oscillator 11 in FIG. 1.

When a frequency signal from the oscillator 11 is input to the cavity 13, a current flows inside the cavity 13 while changing its direction periodically as indicated by the arrows in FIG. 3A. The period at which the current direction changes corresponds to the frequency f₀ of the frequency signal output from the oscillator 11. When a current flows in the cavity 13 in this manner, a magnetic field is generated, as shown in FIG. 3A. The direction of this magnetic field also changes in accordance with this frequency f₀. This magnetic field is formed in the hollow portion of the cavity 13, and its direction changes at time intervals of 1/f₀.

The cavity 13, spacer 21, and sample 14 are equivalent to an LC circuit like the one shown in FIG. 3B. The LC circuit has the characteristic of resonating at frequency fᵣ=(2π)⁻¹(LC)^{-0.5} where L is the inductance of the coil of the equivalent circuit shown in FIG. 3B, and C is the resultant electric capacitance of the two capacitors of the equivalent circuit in FIG. 3B. Such a reentrant cavity is disclosed in, for example, C. T. Van Degrif, Rev. Sci. Instrum., Vol. 45 (1974) 1171.

FIG. 4 is a graph showing the amplitude of a reflected wave from the cavity 13 in FIG. 1 as a function of the frequency of a frequency signal from the oscillator 11 in FIG. 1.

As shown in FIG. 4, the intensity of the reflected wave from the cavity 13 becomes minimum at a resonant frequency fr and gradually increases along a Lorenz curve as the frequency differs from the resonant frequency. In this embodiment, since the sample 14 vibrates, the electric capacitance of the capacitor oscillates at the frequency f. That is, the resonant frequency fᵣ oscillates between fᵣ₋ which is lower than fᵣ, and fᵣ₊ which is higher than fᵣ. As the resonant frequency oscillates, the amplitude value of the reflected wave oscillates with respect to the frequency. When the resonant frequency is fᵣ₊, the reflected wave has a characteristic like that represented by the dotted curve on the right side of FIG. 4. When the resonant frequency is fᵣ₋, the reflected wave has a characteristic like that represented by the dotted curve on the left side of FIG. 4. The characteristic curve of the reflected wave oscillates between the curve set when the resonant frequency is fᵣ₋ and the curve set when the resonant frequency is fᵣ₊.

Since the reflection characteristic oscillates at the frequency f as the resonant frequency oscillates, a signal of the frequency f which has an amplitude proportional to the amplitude of the surface of the sample 14 can be extracted. As the degree of proportionality of this amplitude increases, the sensitivity of detection of an amplitude increases. It is therefore preferable that the amplitude value proportional to the amplitude of the vibration at the surface be as large as possible. For this purpose, the frequency reflected by the cavity 13 is set to a frequency at which the characteristic curve of the reflected wave shown in FIG. 4 has the largest gradient. That is, the frequency f₀ of an output signal from the oscillator 11 is set to a frequency at which the characteristic curve of the reflected wave has the largest gradient as shown in FIG. 4.

As the surface of the sample 14 vibrates and the electric capacitance C increases, the resonant frequency decreases, and the amplitude of the reflected wave from the cavity increases to the value at a point A in FIG. 4. As the surface of the sample 14 vibrates and the electric capacitance C decreases, the resonant frequency increases, and the amplitude of the reflected wave from the cavity decreases to the value at a point B in FIG. 4. If, therefore, the sample surface vibrates at the frequency f, the wave reflected by the cavity and having the frequency f₀ is AM-modulated with the frequency f. The detector 17 detects this signal and can extract a signal of the frequency f which has an amplitude proportional to the amplitude produced in the surface of the sample 14.

The frequency f₀ at which the characteristic curve of the reflected wave has the largest gradient as shown in FIG. 4 may be detected as follows. The cavity 13 is directly vibrated by a vibrator (not shown) to vibrate the sample 14 so as to shift the resonant frequency, thereby detecting a frequency at which the amplitude of a reflected wave oscillates most. The oscillation frequency of the oscillator 11 is then set by using the detected frequency as the frequency f₀.

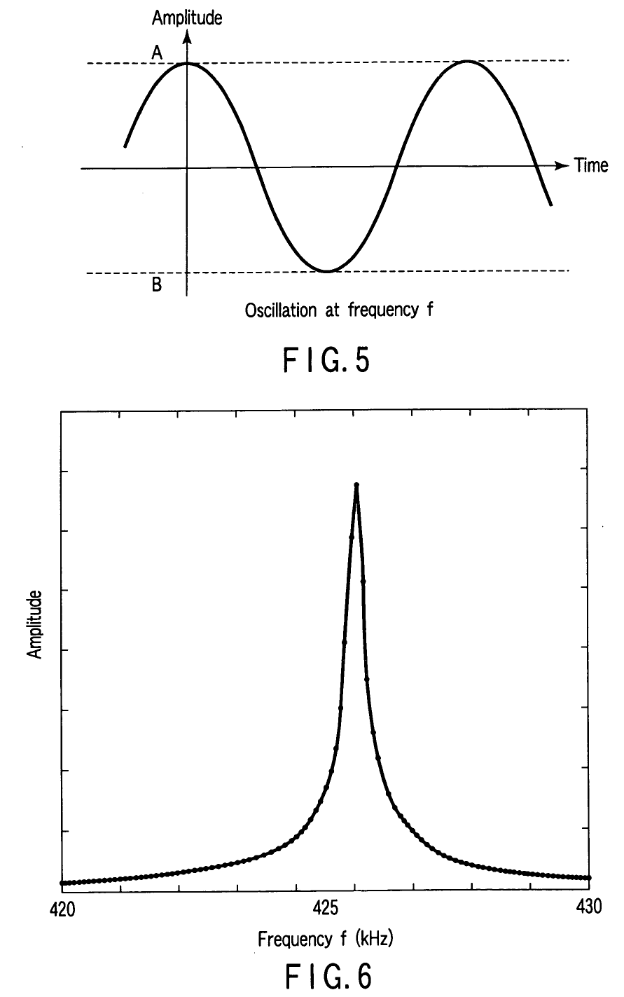

FIG. 5 is a graph showing the amplitude of an output signal from the detector 17 in FIG. 1 as a function of time.

The detector 17 detects an amplitude value that oscillates between A and B in FIG. 4 at the frequency f₀.

FIG. 6 is a graph showing the amplitude of an output signal from the lock-in amplifier 18 as a function of frequency. The frequency on the horizontal axis is twice the frequency output from the oscillator 16, and designated by the computer 19 with respect to the oscillator 16.

The computer 19 sweeps a given frequency band by changing the frequency f. When the frequency designated by the computer 19 coincides with a frequency f₁ corresponding to the fundamental mode of longitudinal waves of the sample 14, a resonance phenomenon occurs, and a peak like the one shown in FIG. 6 appears. The frequency at which this peak appears is the frequency f₁ corresponding to the fundamental mode. It is known that the elastic constant of the sample 14 can be obtained from the frequency f₁ of this fundamental mode. An elastic constant C₁₁ can be obtained by C₁₁=ρ(λf₁)² where ρ is the density of the sample 14, and λ is the wavelength of an ultrasonic wave propagating in the sample 14.

On the graph shown in FIG. 6, a sharp spectrum appears at f₁=425.6 kHz. According to an experiment corresponding to the graph of FIG. 6, ρ=6.02 g/cm³ and λ=16.18 mm. Therefore, C₁₁=2.857×10¹¹ N/m², which almost coincides with the value in a reference (2.75×10¹¹ N/m², Chihiro Hamaguchi, “Solid-State Physics”, Maruzen).

In the experiment, BaTiO₃ single crystal in the form of a cube having a side length of 4.045±0.001 mm (available from Matech in Germany) was used as a sample. Since this sample has no conductivity, a gold evaporated film was attached to the entire surface of the sample to make its surface have conductivity. To supply a current to the sample surface, a lead wire having a diameter of 46 μm was mounted on a corner of the surface with a small amount of silver paste.

The diameter of the cavity 13 is 10 mm, and the thickness of the spacer 21 made of silicon resin is about 10 μm.

The surface of the sample 14 vibrates at a frequency of 0.1 to 3 MHz. The resonant frequency fᵣ of the cavity 13 is about 2.6 GHz. According to this experiment, the oscillation frequency f₀ of the oscillator 11 is about 10,000 times the oscillations frequency f of the oscillator 16. An application voltage applied to the capacitor formed by the sample 14 and the cavity 13 is 140 Vpp.

A network analyzer (model number: HP8753C) was used as the oscillator 11; model number HP86205A, as the directional bridge 12; model number HP8472B, as the detector 17; a network analyzer (model number: HP8753E (time constant: 10 s)), as the lock-in amplifier 18; model number HP33120A, as the oscillator 16; model number NF4005, as the power amplifier 15; and NEC PC9801, as the computer 19.

In this experiment, the electric force acting on the sample surface is on the order of 0.01N. According to the characteristics of this cavity (Q value of about 300), the vibration amplitude of the spectrum observed is estimated to be on the order of 1A. Therefore, the amplitude detection limit of this apparatus can be estimated to be about 0.1 pm.

In this embodiment, the sample is excited by an electrostatic force that hardly causes heat generation, and the vibration state of the sample surface is detected by detecting a change in electric capacitance between the sample surface and an electrode facing it. A change in electric capacitance can be detected with high sensitivity by using high-frequency resonance instead of measurement using a bridge circuit used in the prior art.

As a result, a sample can be measured with high sensitivity by a compact apparatus having a volume of 100 mm³ or less without generating a large amount heat in the sample during measurement.

Since the cavity 13 is compact, high-precision temperature control can be done. There are no theoretical limitations on miniaturization of the sample 14 and cavity 13. If, therefore, with advances in micromachining techniques, a compact cavity can be manufactured, a micrometer-size sample can be measured. In addition, if a heat flow sensor is attached to this apparatus, the above measurement can be done concurrently with thermal analysis. The apparatus can be used at a high temperature by properly selecting a material for a cavity.

In the resonant ultrasonic spectroscopy apparatus according to this embodiment, since an electric force directly acts on the surface of the sample 14, the sample 14 is only required to be placed on the cavity. There is no need to mechanically clamp a sample or fix it with an adhesive or the like as in the case of a P type apparatus using piezoelectric transducers. For this reason, in the resonant ultrasonic spectroscopy apparatus according to this embodiment, a sample is not distorted by external static stress, and hence a modulus of elasticity can be measured with high precision.

### SECOND EMBODIMENT

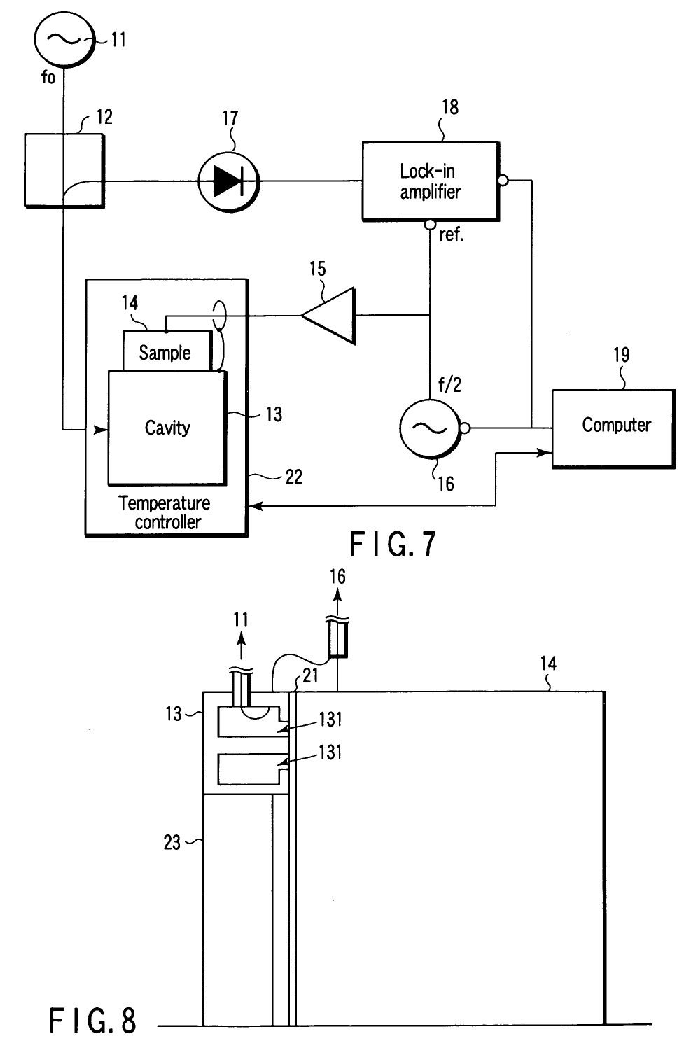

FIG. 7 is a block diagram of a resonant ultrasonic spectroscopy apparatus according to the second embodiment of the present invention.

This embodiment differs from the first embodiment only in that a temperature controller 22 is added. The temperature controller 22 is used to maintain the temperature of a sample 14 and cavity 13 at a desired temperature. The temperature controller 22 encloses the sample 14 and cavity 13.

As the temperature controller 22, a temperature stabilizer (also called a thermostat) disclosed in A. Kojima, C. Ishii, K. Tozaki, S. Matsuda, T. Nakayama, N. Tsuda, Y. Yoshimura, and H. Iwasaki, Rev. Sci. Instrum. Vol. 68 (1997) 2301 is used.

By placing the sample 14 and cavity 13 descried in the first embodiment in the temperature controller 22, a temperature stability of 1 mK can be obtained, and hence stable spectrum characteristics can be obtained.

As a result, a resonant ultrasonic spectrum waveform can be measured with high sensitivity and high S/N ratio under the condition that the temperature stability of the sample is +1 mK. Other effects are the same as those in the first embodiment.

### THIRD EMBODIMENT

FIG. 8 is a diagram of a resonant ultrasonic spectroscopy apparatus according to the third embodiment of the present invention.

The arrangement of this embodiment differs from that of the first embodiment in that a fulcrum 23 is added, and a cavity 13 laterally adds vibrations to a sample 14 which is larger than the cavity 13.

The sample 14 is placed so as not to shift as the cavity 13 vibrates. For example, the bottom surface of the sample 14 is fixed with an adhesive or the like. The cavity 13 is placed on the fulcrum 23 such that the upper portion of the cavity vibrates, because the sample 14 does not easily shift. If the fixed state of the sample 14 is maintained, the upper portion of the sample 14 need not be vibrated.

By laterally adding vibrations from the cavity 13 to the sample 14 as in this embodiment, the elastic constant of the sample 14 can be obtained from transverse waves. Other effects are the same as those in the first embodiment.

When more commonly used devices are to be used in place of the devices used in the above embodiments, the oscillator 11 (model number: HP8753C) may be replaced with a general high-frequency oscillator, and the lock-in amplifier 18 (model number: HP8753E) may be replaced with a high-frequency band lock-in amplifier.

According to the above embodiments of the invention, a sample can be excited by an electrostatic force that hardly cause heat generation, and a measuring portion can be made smaller than that of a conventional apparatus. Therefore, the temperature of the sample can be maintained very stably.

In addition, according to the above embodiments of the invention, the vibrating state of a sample surface is detected by detecting a change in electric capacitance between the sample surface and an electrode (equivalent to a capacitor) facing it. In this manner, a change in electric capacitance due to the capacitor can be detected with high sensitivity by using a high-frequency resonant circuit.

As a consequence, the modulus of elasticity of the sample can be measured with high precision.

In addition, the apparatus according to the embodiment of the present invention has merits that, for example, the stress acting on a sample during measurement is lower than that in a conventional apparatus, and a resonant mode can be easily specified in analysis of measurement data. The embodiment of the present invention is a new method which differs from those of currently available resonant ultrasonic spectroscopy apparatuses in a method of generating ultrasonic waves and a detection method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A resonant ultrasonic spectroscopy apparatus which detects a property of a sample at least whose surface is a conductor, the apparatus comprising:
a cavity which vibrates the sample and is combined with the sample to be equivalent to an LC circuit;
an insulator which electrically insulates the sample from the cavity, the insulator being placed between the sample and the cavity;
a first output unit configured to output, to the cavity, a first frequency signal including a frequency which causes the cavity combined with the sample to function as an equivalent circuit of an LC circuit;
a second output unit configured to output, to the sample and the cavity, a second frequency signal including a frequency which vibrates the sample; and
an amplitude detection unit configured to detect, based on the second frequency signal, an amplitude of a reflected signal reflected from the cavity, the reflected signal being caused by the first frequency signal.

2. The apparatus according to claim 1, wherein a conductor portion of the sample and a conductor portion of the cavity form an equivalent circuit of a capacitor, and the sample is vibrated by an electric force acting between the conductor portions.

3. The apparatus according to claim 1, wherein the cavity forms an LC circuit by a capacitor which is an equivalent circuit formed between the cavity and the sample, and a coil which is an equivalent circuit generated in the cavity.

4. The apparatus according to claim 1, further comprising:
a temperature stabilizer which stabilizes a temperature of the sample, the sample and the cavity are placed in the temperature stabilizer.

5. The apparatus according to claim 1, wherein the frequency of the first frequency signal and the frequency of the second frequency signal belong to different frequency bands.

6. The apparatus according to claim 1, wherein is the cavity is a reentrant resonator.

7. The apparatus according to claim 1, wherein the cavity is placed at a position where the cavity vibrates the sample from below.

8. The apparatus according to claim 1, wherein the cavity is placed at a position where the cavity vibrates the sample laterally.

9. A cavity which is placed, through an insulating material, in contact with a sample at least whose surface is a conductor and inputs a predetermined frequency signal, the cavity comprising:
a first projection part configured to be capacitively coupled to the sample;
a second projection part configured to be capacitively coupled to the sample; and
a connecting portion configured to connect the first projection part and the second projection part so as to form a hollow portion in the cavity, wherein
one end of the first projection part and one end of the second projection part are electrically connected to each other, the other end of the first projection part and the other end of the second projection part are electrically insulated from each other,
a coupling capacitance between the other end of the first projection part and the other end of the second projection part is smaller than each of a coupling capacitance between the sample and the first projection part and a coupling capacitance between the sample and the second projection part, and
the connecting portion becomes a coil as an equivalent circuit upon reception of the frequency signal.

10. The cavity according to claim 9, wherein an equivalent circuit of a capacitor is formed between the cavity and a conductor portion of the sample, and the sample is vibrated by an electric force acting between the cavity and the conductor portion.

11. The cavity according to claim 9, wherein an LC circuit is formed by a capacitor which is an equivalent circuit formed between the cavity and the sample, and a coil which is an equivalent circuit generated in the cavity.

12. The cavity according to claim 9, wherein the cavity is placed at a position where the cavity vibrates the sample from below.

13. The cavity according to claim 9, wherein the cavity is placed at a position where the cavity vibrates the sample laterally.

14. A cavity which is placed, through an insulating material, in contact with a sample at least whose surface is a conductor and to which a second frequency signal is input, comprising:
a first input part configured to input a first frequency signal;
a second input part configured to input the second frequency signal; and
a connecting portion part configured to be so formed as to form a hollow portion in the cavity, made of a conductor, and connected to the first input part and the second input part, wherein
the cavity vibrates the sample based on the second frequency signal and is combined with the sample to function as an equivalent ciruit of an LC circuit based on the first frequency signal.

15. The cavity according to claim 14, wherein the cavity is placed at a position where the cavity vibrates the sample from below.

16. The cavity according to claim 14, wherein the cavity is placed at a position where the cavity vibrates the sample laterally.

17. The cavity according to claim 14, wherein a frequency of the first frequency signal and a frequency of the second frequency signal belong to different frequency bands.
